(19) United States
(12) Patent Application Publication
(10) Pub. No.: US 2020/0410071 A1
(43) Pub. Date: Dec. 31, 2020

(54) VOICE RECOGNITION ALERTS(V.R.A)

(71) Applicant: Elisha Tweneboah Kodua, Dallas, TX (US)

(72) Inventor: ELISHA TWENEBOAH KODUA, DALLAS, TX (US)

(21) Appl. No.: 16/455,434

(22) Filed: Jun. 27, 2019

(51) Int. Cl. G06F 21/32; G10L 17/00; G06F 21/40

(52) U.S. Cl. CPC G06F 21/32; G06F 21/40; G10L 17/005

(57) ABSTRACT

Voice Recognition Alerts is designed to combat an unauthorized online account usage and transactions. It is an additional transaction and account management security system that will be required by the various financial institutions, online payment systems, online healthcare accounts and other online accounts that contain or require user personal information such as, full name, date of birth, social security and driver's license to confirm the validity of all transactions as well as account authentication before granting access. The verification process involves making a voice recording of an answer to a selected security question on file. The account holder will then be asked to confirm transactions by verbally providing an answer to the security question. If the answer and the voice match the one recorded on file, account access or transaction will be approved. If neither the voice nor the answer matches the one file, account or transaction will be declined.

### BACKGROUND OF THE INVENTION VOICE RECOGNITION ALERTS (VRA)

The ongoing cyber war in the world today cannot be overlooked by any organization whether it's nonprofit or for profit.

Companies and organizations holding sensitive data are particularly vulnerable to cyber-attacks; They are the most targeted group of attackers. Even though much effort and measures have been put in place to combat these intruders, the attacks seem to be increasing every day as if nothing is being done about it. The intruders are doing everything possible to take advantage of modernday technology and rob people, organizations and corporations.

For this purpose, VOICE RECOGNITION ALERTS (VRA) is established to provide extra security to both online and offline transactions.

### DETAILED DESCRIPTION

The description of the Voice Recognition System can be detailed under the following categories;

Financial institutions
Online payment systems Healthcare accounts
Other online account users Smartphones and laptops users. Mobile sim card registration
Location details Home security Identity verifications
Gun detection

### Voting

### For Financial Institutions

First of all, the account holders will be required by the financial institutions to set a security question at the time of opening the account. The answer to the security questions will be in a voice from where the account holder will be prompted to speak or record the answer to the selected security question.

This voice recorded answer will be kept on file for verification purposes.

The account holder will then be asked to set a transaction limit of which verification would be required.

Any transactions beyond the set amount would require the bank to make an automated call to the account holders phone number on file and asked to confirm by answering a secret question on file.

The system will then make sure the answer to the security question matches the voice as recorded on file.

If the system recognizes the voice of the account holder then the transaction will be approved. If not, then the transaction will be declined.

Online Payment Systems

Anytime user wants to access an online payment system account, Voice Recognition Alert Verification and authentication process will be required. The account holder will be required to set a voice recording security question at the time of creating the online account. The answer to the security questions will be in a voice from where the account holder will be prompted to speak or record the answer

to the selected security question.

This voice recorded answer will be kept on file for verification purposes. Anytime the user wants to access the account, a call will be made by the system to the users registered phone number on file to answer a

security question on file and make sure the voice matches the recorded one on file.

User access will be denied if the recorded security answer does not match the one on file. If the user gets security answer correct but users voice does not match the recorded voice on file, there will no account access to such a user? Upon three unsuccessful attempts, the account will be temporarily

blocked requiring the user to speak to a live representative at the fraud department.

### Healthcare Accounts

The account holder will be required by the healthcare provider or facility to set a voice recording security question at the time of creating the online account. The answer to the security questions will be in a voice from where the account holder will be prompted to speak or record the answer to the selected security question.

This voice recorded answer will be kept on file for verification purposes. Anytime the user wants to access the account, a call will be made by the system to the users registered phone number on file to answer a

security question on file and make sure the voice matches the recorded one on file.

User access will be denied if the recorded security answer does not match the one on file. If the user gets security answer correct but users voice does not match the recorded voice on file, There will no account access to such a user? Upon three unsuccessful attempts, the account will be temporarily blocked requiring the user to speak to a live representative at the fraud department. OTHER

### Corporations

All online accounts users who may opt-in for Voice Recognition Alert (VRA) will be required to go

through VOICE RECOGNITION ALERT verification and authentication process in order to access their account.

They will be required to set up a voice recorded security question at the time account was opened or even if the account has been opened and the user opt-in for VRA, the user will be allowed to follow

the process by recording their security question on file.

A call will be made by the system to the users registered phone number on file to answer a security question on file and make sure the voice matches the recorded one on file.

User access will be denied if the recorded security answer does not match the one on file. If the user gets security answer correct but users voice does not match the recorded voice on file, There will no account access to such a user? Upon three unsuccessful attempts, the account will be temporarily

blocked requiring the user to speak to a live representative at the fraud department. LAPTOPS AND SMARTPHONE USERS

All laptops and smartphone users who opt-in for voice recognition alert at the initial set may will be required to voice record their answer to the selected security question on file. Users will be required to verbally provide an answer to the security question before they will be able to access their laptops and smartphones. If the system recognizes the voice of the user and the security answer matches the one on file, the phone or the laptop will be opened and the user will be able to have

access. If the voice matches the one recorded on file but the security answer does not match the one on file, account access will not be granted. In the same way, if the security answer matches the on file but the voice does not match the recorded one on file, account access will be denied.
Mobile Money Account Before you set up a mobile money account, the account holder will be required to set up a security question. The answer to the security questions will be in a voice from where the account holder will be prompted to speak or record the answer to the selected security question.

This voice recorded answer will be kept on file for verification purposes.

The account holder will then be asked to select two security keys on his/her smartphone. In case of an emergency where the account holder's life is in danger, one of the keys (danger key) will be pressed three times followed by their country's emergency line or short code before providing an answer to the voice recorded security questions on file.

This security key will then activate the location of the user and also send a signal to the customer service or the nearby law enforcement that the account holders' life is in danger.

When this happens, even if the user's voice and the security answer match the one on file, the withdrawal will not be allowed but will be placed on hold for further verification and authentication since the account holder's life is in danger. This could be that the user is being forced to withdraw money from their mobile money account.

NORMAL KEY In the case where the account holder wants to withdraw money in a safe location without his life being in danger (normal key), the other second selected key will be pressed three times to enable the user to activate and respond to the voice recorded security questions before allowing to withdraw money. If the voice and the security answer match the one on file, withdrawals will be allowed.

If the voice matches the one on file but the security answer does not, access will be denied. If neither the Voice nor the answer matches the one on file, account cases will be denied.

If the user gets the security answer correct but the voice does not match the one on file, account access will be denied. Upon three unsuccessful attempts, the account will be blocked temporarily and require the user to contact a live representative for further verifications.

For example, #hash key means danger

*key means normal not in danger.

If the user refuses to answer the call three times the system will automatically block users account temporarily for further verification.

This will help prevent fraudulent acts through mobile money accounts and also ensure the security of the users and their deposits or funds.

### Mobile Sim Card Registration

Before any sim card can be registered, Voice Recognition alert process in claim 2 key selection process will be followed.

The account holder will be allowed to select a security key on his/her smartphone before registering their sim card. Existing users who have already registered their sim card will be allowed to amend their registration by selecting a security key. In case of an emergency where the account holder's life is in danger, the security keypad will be pressed three times instantly followed by their country's emergency line or short code. As soon as the user presses the key three times together with the emergency line, the system will activate the location of the user and send a signal to the nearest law enforcement that users' life is in danger.

For instance, the user in the United States select hash# as his security key. In case of danger such sickness or any life-threatening events, the user will press the hash# key three times followed by 911 and immediately the location of the

user will be activated and connected to the nearest law enforcement agencies or agent which will signal to them that users' life is in danger.

User can share such keys to their immediate relatives only.

This will system will help reduce kidnapping and also ensure the safety of every country and its citizens most especially the developing countries.

### Tracking Suspicious Caller Location

If VRA user wants to track the location of a suspicious caller, User will log in into VRA app immediately after the call and follow the following instructions.

Click on track last caller location. Enter your selected security key three times and hit enter key. The location details of the caller will be displayed even if the last caller ID is unknown.

### DESCRIPTION OF FIGURES

FIG. 1A shows Voice Recognition Alert Server used to grant or deny user access.

FIG. 1B shows Voice Recognition Alert Application Security Database used to verify financial institutions, online payment systems and healthcare account.

FIG. 2 shows how the user can use an installed VRA app by smartphone and laptop manufacturers to unlock their smart device and personal computing device.

FIG. 3 shows how the user can use an VRA software to unlock their smart device and personal computing device.

FIG. 4 shows how a user is being asked by their financial institution to verify the recorded voice on file before granting access to their online accounts.

FIG. 5 shows how the user is being asked by their online payment system providers to verify the recorded voice on file before granting access to their online accounts. FIG. 6 shows how the user is being asked by their healthcare facility to verify the recorded voice on file before granting access to their online accounts

FIG. 6 shows how the user is being asked by their healthcare facility to verify the recorded voice on file before granting access to their online accounts

FIG. 7 shows how the user is being asked by other online account providers to verify the recorded voice on file before granting access to their online accounts.

FIG. 8 shows how the user uses three selected keys to indicate either transaction is being done under stress or its normal transaction.

FIG. 9 shows whether user is denied or given access to a transaction that is being done under stress or not.

FIG. 10 shows how the user uses the three selected security keys followed by emergency short code to send their location to the nearby law enforcement to indicate their life is in danger.

FIG. 11 shows how a user can track a suspicious caller with the VRA app

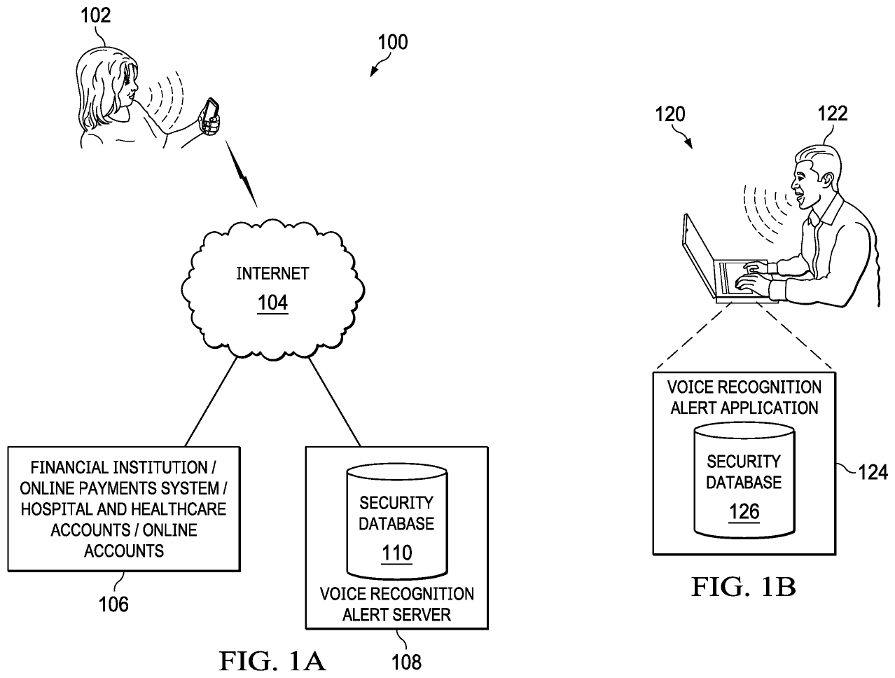

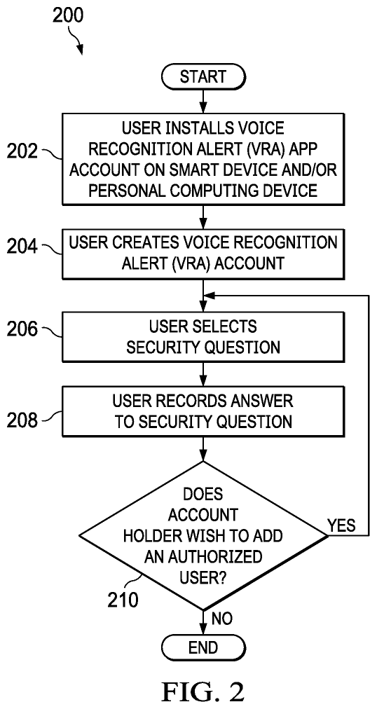

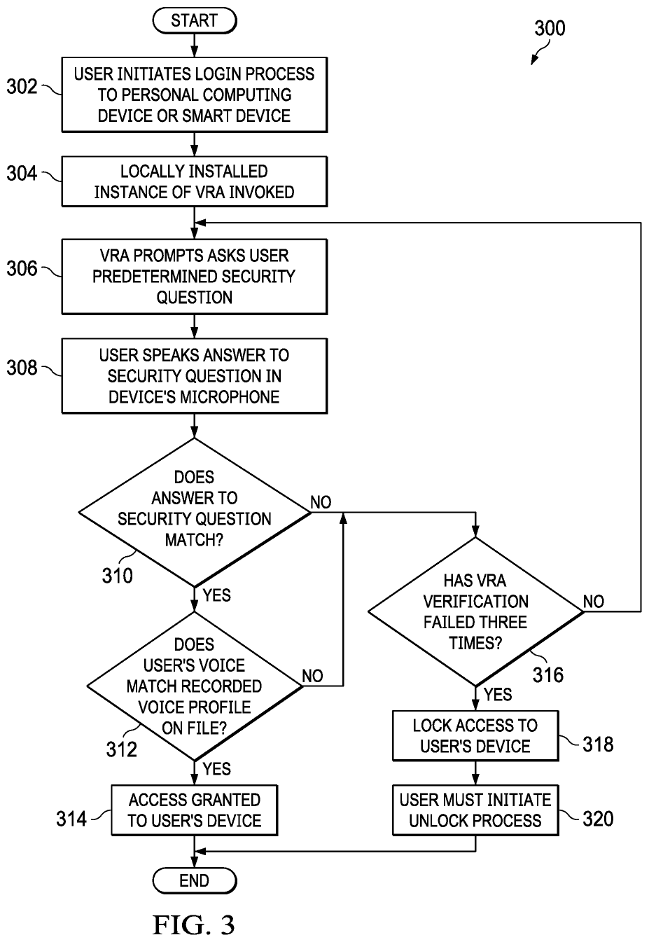

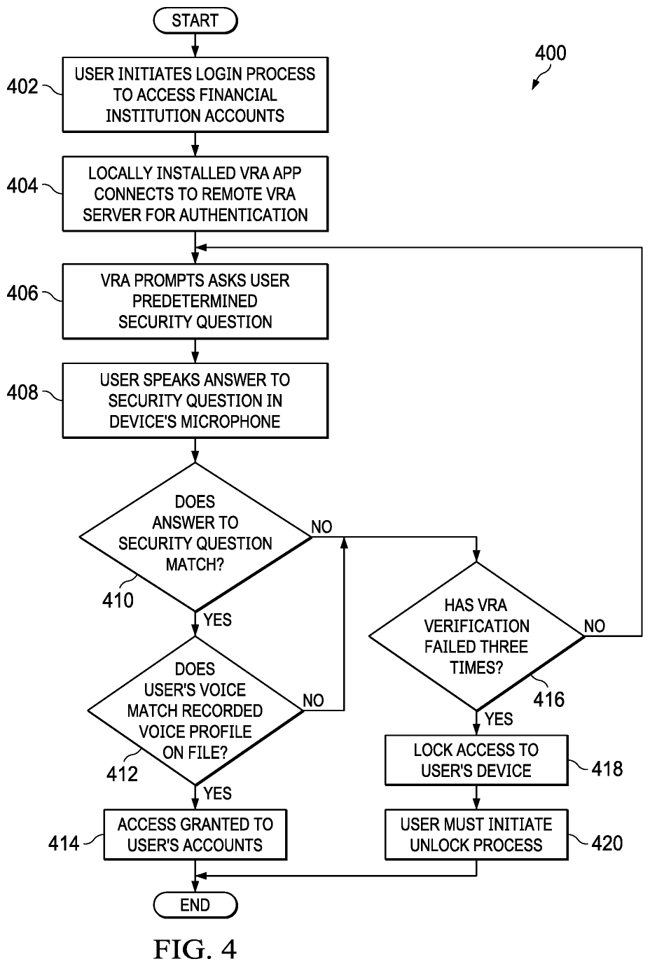

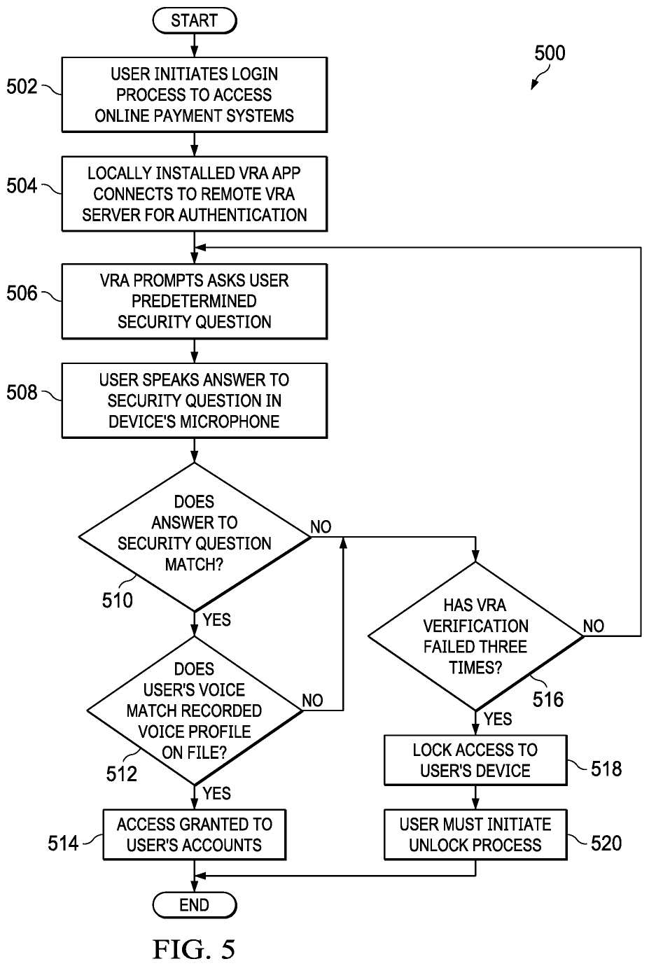

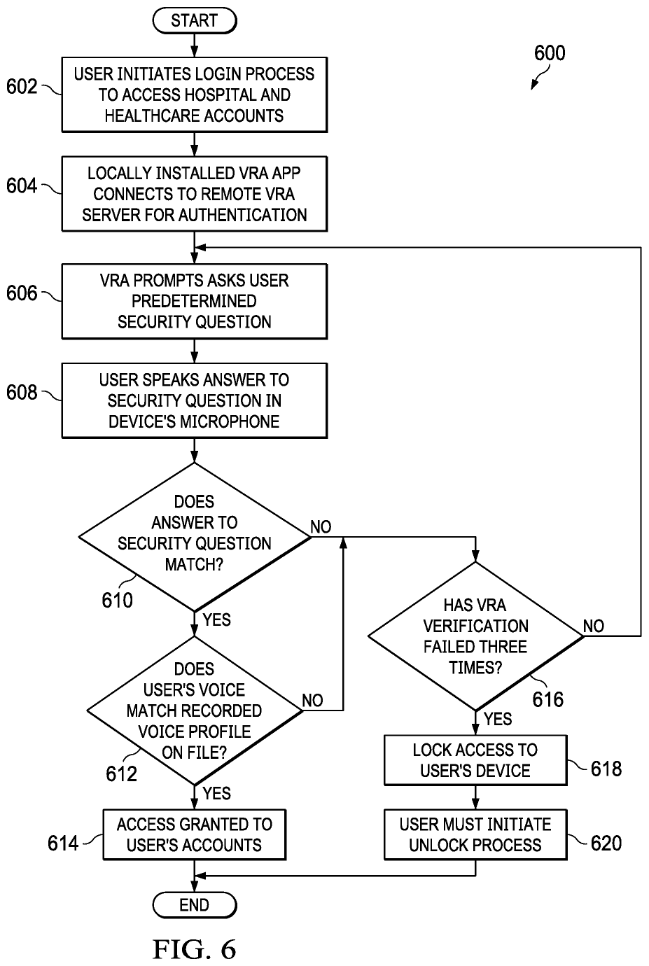

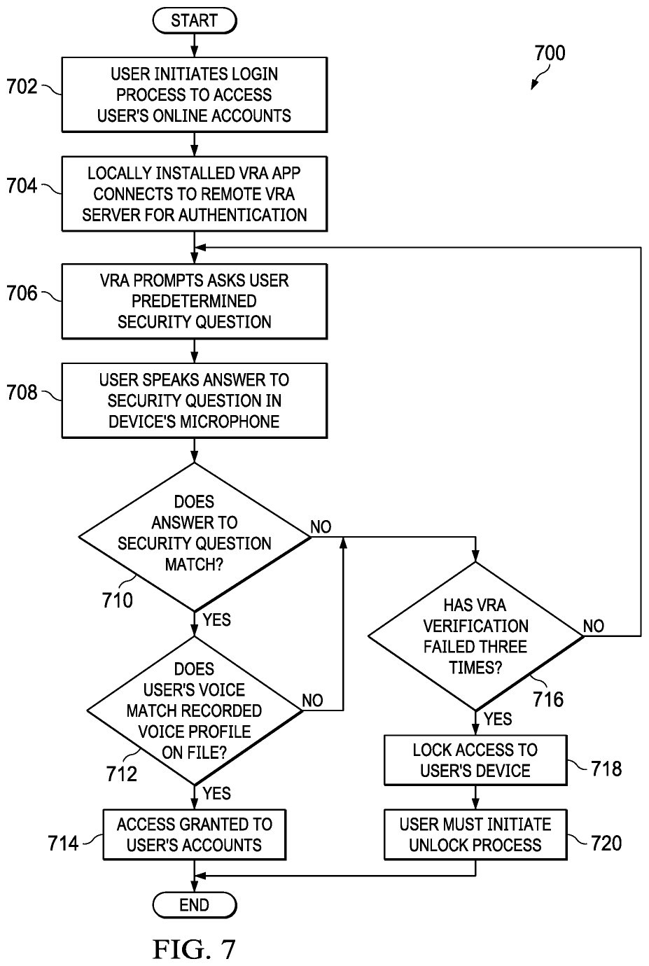

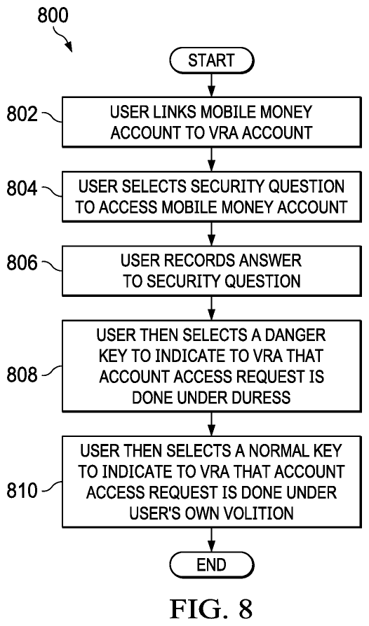

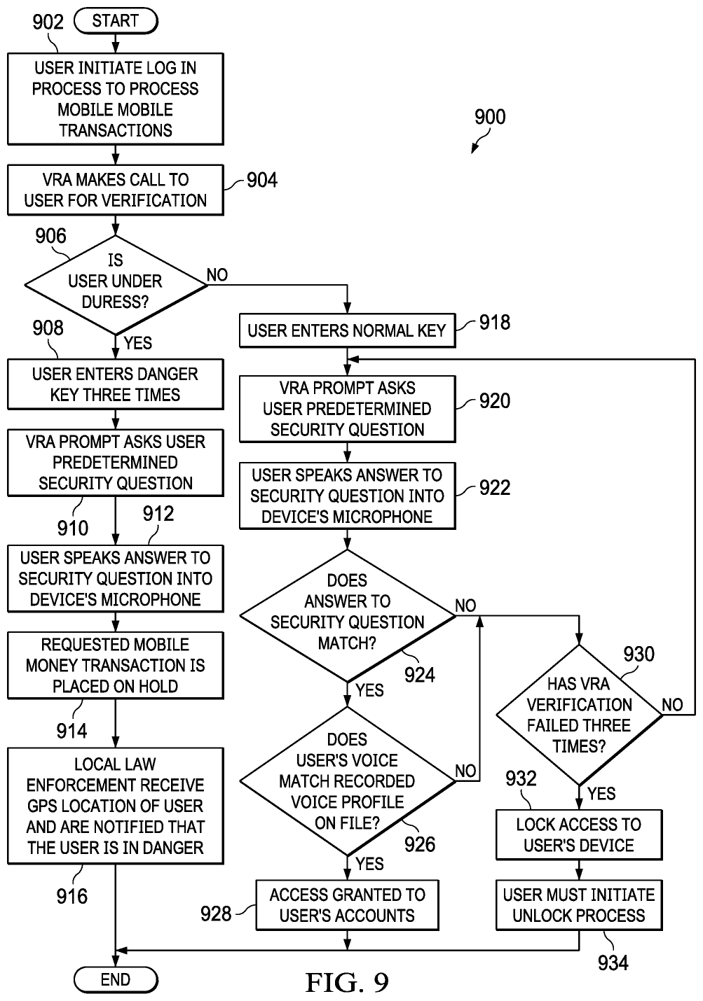

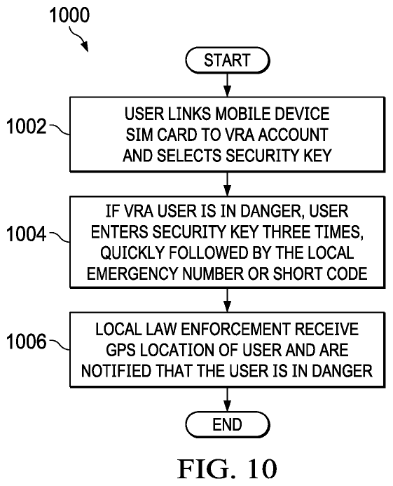

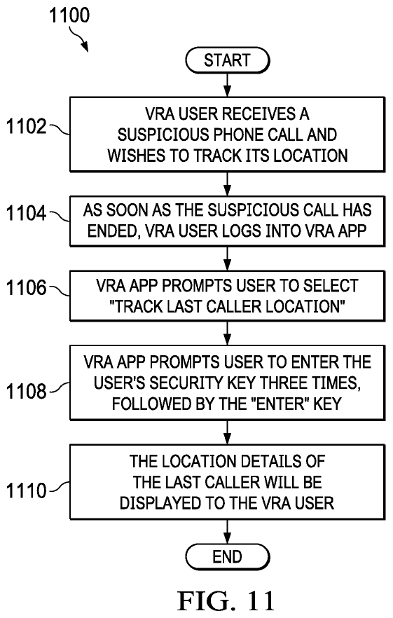

### HOW OFTEN SHOULD THIS BE DONE

The account holder may periodically update his or her voice recording as well as their security questions on file to help strengthen the security system. Also, anytime there is a transaction either in-store or online that exceeds set amount verification will be required. Again, anytime user or account holder wants to access his or her online account at any time and in all places, verification will be required.

### Language

All users will be given an option to select a language they are comfortable with. They may select from one of the following languages:

### American English Akan

### Arabic Bengali British English Chinese French German

### Hindi Japanese Javanese Korean Portuguese Russian Spanish Tamil Turkish Urdu Vietnamese

### Invention Summary

Voice Recognition Alerts (VRA) is designed to combat unauthorized online account usage and transactions. It is an additional transaction and account management security system or an extra verification and authentication process that will be required by the various financial institutions, online payment systems, online healthcare accounts and other online accounts that contain or require user personal information such as, full name, date of birth, social security and driver's license or any government issued identification card to confirm the validity of all transactions as well account authentication before granting account access. The verification process involves making a voice recording of an answer to a selected security question on file. The account holder will then be asked to confirm transactions by verbally providing an answer to the security question. If the answer and the voice match the one recorded on file, account access or transaction will be approved. If neither the voice nor the answer matches the one file, account or transaction will be declined. If the voice matches the one recorded on file but the security answer does not match the one on file, account access will be denied. In the same way, if the security answer matches the on file, but the voice does not match the recorded one on file, account access will be denied. The system also allows mobile phone users to select a security key on their smartphone before registering their sim card. In case of an emergency where the account holder's life is in danger, the security key will be pressed three times instantly followed by their country's emergency line or short code. As soon as the user presses the key three times together with the emergency line, the system will activate the location of the user and send a signal to the nearest law enforcement that users' life is in danger.

I. (canceled)

II. (canceled)

III. (canceled)

IV. (canceled)

V. (canceled)

VI. The said invention will allow the account holder to select a security question and provide an answer to the security question in voice recording form. The voice recorded answer will be saved on file for verification purposes.

VII. (canceled)

VIII. (canceled)

IX. (canceled)

X. (canceled)

XI. (canceled)

XII. (canceled)

XIII. (canceled)

XIV. (canceled)

XV. (canceled)

XVI. (canceled)

XVII. The said invention will allow mobile phone users to select a security key on their smartphone during the registration of their sim cards. In case of an emergency where the account t holder's life is in danger, the security key will be pressed three times instantly followed by their country's emergency line or short code to activate the user's location.

XVIII. (canceled)

XVIII. The said invention allows smartphone users to track a suspicious caller with the Voice Recognition alert app by logging into the VRA app and follow the system instructions.
